(19) United States
(12) Patent Application Publication
(10) Pub. No.: US 2020/0353536 A1
(43) Pub. Date: Nov. 12, 2020

(54) Fe-Co ALLOY POWDER, MOLDED BODY FOR INDUCTOR USING SAME, AND INDUCTOR

(71) Applicant: DOWA ELECTRONICS MATERIALS CO., LTD., Tokyo (JP)

(72) Inventors: Hiroki KANAYA, Tokyo (JP); Masahiro GOTOH, Tokyo (JP)

(21) Appl. No.: 16/957,142

(22) PCT Filed: Dec. 24, 2018
(86) PCT No.: PCT/JP2018/047416

§ 371 Date: Jun. 23, 2020

(30) Foreign Application Priority Data
Jan. 17, 2018 (JP) 2018-005410

(51) Int. Cl. B22F 1/00; B22F 9/24; C22C 38/10; C22C 38/02; C22C 38/00; H01F 1/147

(52) U.S. Cl. CPC B22F 1/0011; B22F 9/24; C22C 38/10; C22C 2202/02; C22C 38/002; H01F 1/147; B22F 2301/35; C22C 38/02

(57) ABSTRACT

A Fe—Co alloy powder has a small particle diameter, can achieve high μ′ in a high frequency band, and has high heat resistance. The Fe—Co alloy powder can be obtained in such a manner that an acidic aqueous solution containing a trivalent Fe ion and a Co ion is neutralized with an alkali aqueous solution in the presence of a phosphorus-containing ion. This provides a slurry of a precipitate of a hydrated oxide. Then, a silane compound is added to the slurry to coat the precipitate of the hydrated oxide with a hydrolyzate of the silane compound. The precipitate of the hydrated oxide after coating is recovered through solid-liquid separation. The recovered precipitate is heated to provide iron particles coated with a silicon oxide, and then the silicon oxide coating is removed through dissolution.

### TECHNICAL FIELD

The present invention relates to Fe—Co alloy powder that is suitable for the production of a powder compact magnetic core for an inductor, a method for producing the same, a molded body for an inductor using the same, and an inductor.

### BACKGROUND ART

Powder of an iron based metal, which is a magnetic material, molded as a powder compact has been used as a magnetic core of an inductor. Examples of the known iron based metal include powder of an iron based alloy, such as an Fe based amorphous alloy containing large amounts of Si and B (PTL 1), and an Fe—Si—Al based Sendust or permalloy (PTL 2). These kinds of iron based metal powder have been formed into a composite with an organic resin and into a coating material, and applied to the production of a surface mounting coil component (PTL 2).

A power inductor, which is one kind of inductors, is being used in higher frequencies in recent years, and an inductor capable of being used at a high frequency of 100 MHz or more is demanded. As a production method of an inductor for a high frequency band, for example, PTL 3 describes an inductor using a magnetic material composition obtained by mixing nickel based metal powder having a minute particle diameter with iron based metal powder having a large particle diameter and iron based metal powder having an intermediate particle diameter, and a production method therefor. The use of the nickel based metal powder having a minute particle diameter mixed is for the enhancement of the packing density of the magnetic materials by mixing powder having different particle diameters, resulting in the enhancement of the permeability of the inductor. However, according to the technique described in PTL 3, the packing density of the powder compact is increased by mixing the magnetic materials having different particle diameters, but there is a problem that the increase of the permeability of the finally resulting inductor is small.

### CITATION LIST

### Patent Literatures

PTL 1: JP-A-2016-014162

PTL 2: JP-A-2014-060284

PTL 3: JP-A-2016-139788

PTL 4: JP-A-2002-075721

### SUMMARY OF INVENTION

### Technical Problem

It is considered that the permeability of the inductor obtained by the technique of PTL 3 is not significantly high since the permeability of the nickel based metal powder is lower than that of the iron based metal powder. Accordingly, it is expected that an inductor having a high permeability can be obtained by mixing Fe—Co alloy powder having a minute particle diameter and a higher permeability than the nickel based metal. However, Fe—Co alloy powder having a minute particle diameter of 0.8 μm or less has not been obtained, and there has been a limitation in the enhancement of the permeability of the inductor.

The present applicant has disclosed, in Japanese Patent Application No. 2017-134617, Fe powder that has a particle diameter of from 0.25 to 0.80 μm, an axial ratio of 1.5 or less, and a high permeability μ′ at 100 MHz, silicon oxide-coated Fe alloy powder, and a production method thereof. In the production method described in the application, Fe powder is produced by a wet method with a phosphorus-containing ion co-existing, and at this time, Fe powder coated with a silicon oxide containing a small amount of phosphorus is obtained. However, the Fe powder coated with a silicon oxide containing a small amount of phosphorus has a problem of low heat resistance. With the low heat resistance, the Fe powder is oxidized in a high temperature environment (for example, 200° C. or more) in the production of an electronic component, failing to provide an electronic component having desired magnetic characteristics. Accordingly, there has been a demand of magnetic metal powder that has a small particle diameter, a high permeability, and high heat resistance. For the enhancement of the heat resistance of Fe powder, the formation of an alloy thereof with a metal, such as Co, may be considered. For example, as the Fe—Co alloy powder obtained by alloying Co, PTL 4 describes Fe—Co based particles containing Co in a mass ratio of more than 3% and less than 35%, but the particles have an average particle diameter exceeding 30 μm, and Fe—Co alloy powder that has a submicron particle diameter and a low axial ratio has not yet been obtained.

In view of the aforementioned problem, an object of the present invention is to provide Fe—Co alloy powder that has a small particle diameter, can achieve high μ′ in a high frequency band, and has high heat resistance.

### Solution to Problem

For achieving the object, the present invention provides Fe—Co alloy powder containing Fe—Co alloy particles containing Co in a Co/(Fe+Co) molar ratio of 0.0001 or more and 0.05 or less, having an average particle diameter of 0.25 μm or more and 0.80 μm or less, and an average axial ratio of 1.5 or less.

It is preferred that the Fe—Co alloy powder has a P content of 0.05% by mass or more and 1.0% by mass or less based on the mass of the Fe—Co alloy powder. It is preferred that the Fe—Co alloy powder has a heat resisting temperature of 225° C. or more, which is defined by a temperature at which the mass of the Fe—Co alloy powder increases by 1.0% by mass. It is preferred that a molded body obtained by mixing the Fe—Co alloy powder and a bisphenol F type epoxy resin in a mass ratio of 9/1 and pressure-molding the mixture has a real part μ′ of a complex relative permeability of 6.2 or more and a loss coefficient tan δ of a complex relative permeability of 0.1 or less, measured at 100 MHz.

The present invention also provides a molded body for an inductor containing the Fe—Co alloy powder, and an inductor containing the Fe—Co alloy powder.

### Advantageous Effects of Invention

According to the present invention, Fe—Co alloy powder that has a small particle diameter, can achieve high μ′ in a high frequency band, and has high heat resistance can be provided.

### BRIEF DESCRIPTION OF DRAWING

FIG. 1 is an SEM image of the Fe—Co alloy powder obtained in Example 1.

### DESCRIPTION OF EMBODIMENTS

### [Fe—Co Alloy Particles]

The Fe—Co alloy particles obtained by the present invention are particles of substantially pure Fe—Co alloy except for P and other impurities that are unavoidably incorporated due to the production process thereof. The Fe—Co alloy particles preferably have an average particle diameter of 0.25 μm or more and 0.80 μm or less and an axial ratio of 1.5 or less. Only in the case where the average particle diameter and the axial ratio are in the ranges, large s′ and sufficiently small tan δ can be achieved simultaneously. The average particle diameter that is less than 0.25 μm is not preferred since s′ may be small. The average particle diameter that exceeds 0.80 μm is not preferred since tan δ may be increased associated with the increase of the eddy current loss. The average particle diameter is more preferably 0.30 μm or more and 0.65 μm or less, and the average particle diameter is further preferably 0.40 μm or more and 0.65 μm or less. The average axial ratio that exceeds 1.5 is not preferred since s′ may be decreased due to the increase of the magnetic anisotropy. The lower limit of the average axial ratio is not particularly determined, and the particles having an axial ratio of 1.10 or more may be generally obtained. The coefficient of variation of the axial ratio may be, for example, 0.10 or more and 0.25 or less. In the description herein, the term Fe—Co alloy particles may be used in the case where the individual Fe—Co alloy particles are targeted, and the Fe—Co alloy particles may be expressed as Fe—Co alloy powder in the case where the average characteristics of the aggregate of the Fe—Co alloy particles are targeted.

### [Co Content]

The Fe—Co alloy particles of the present invention preferably contain Co in a Co/(Fe+Co) molar ratio (which may be hereinafter referred to as a Co ratio) of 0.0001 or more and 0.05 or less, more preferably in a Co ratio of 0.0003 or more and 0.05 or less, and further preferably in a Co ratio of 0.0003 or more and 0.03 or less. In the case where the Co ratio is less than 0.0001, the effect of enhancing the heat resistance of the Fe—Co alloy particles may be insufficient. By increasing the Co ratio from 0.0001, the heat resisting temperature of the Fe—Co alloy particles is increased, but by further increasing the Co ratio, the heat resisting temperature is decreased. The Co ratio that exceeds 0.05 is not preferred since the effect of enhancing the heat resistance of the Fe—Co alloy particles may be insufficient.

Although the mechanism that the heat resisting temperature of the Fe—Co alloy particles has a peak with respect to the Co ratio is unclear, the present inventors estimate that in the formation of a hydroxide of Fe containing a hydroxide of Co as a precursor of the Fe—Co alloy particles described later, phase separation occurs with the increase of the Co ratio, and as a result, the amount of Co dissolved in Fe is decreased in the Fe—Co alloy particles.

### [P Content]

The Fe—Co alloy particles obtained by the present invention are produced by a wet method in the presence of a phosphorus-containing ion as described later, and therefore substantially contain P. The average P content in the Fe—Co alloy powder constituted by the Fe—Co alloy particles used in the present invention is preferably 0.05% by mass or more and 1.0% by mass or less based on the mass of the Fe—Co alloy powder. The P content that is outside the range is not preferred since it may be difficult to produce the Fe—Co alloy particles that have the average particle diameter and the axial ratio described above. The P content is more preferably 0.1% by mass or more and 0.50% by mass or less. The P contained does not contribute to the enhancement of the magnetic characteristics, but may be allowed as far as the content is in the range.

### [Heat Resisting Temperature]

It is estimated that the Fe—Co alloy powder of the present invention is exposed to an environment, for example, of approximately 200° C. or more in the production of an electronic component, which is the purpose of the Fe—Co alloy powder, as described above. Accordingly, the Fe—Co alloy powder preferably has a heat resisting temperature of 225° C. or more, which defined by the definition described below. In the present invention, the upper limit of the heat resisting temperature of the Fe—Co alloy powder is not particularly determined, and the powder having a heat resisting temperature of approximately 260° C. may be obtained as described later.

In the present invention, the heat resisting temperature of the Fe—Co alloy powder is defined by the temperature at which the mass of the Fe—Co alloy powder as a test specimen increases by 1.0% by mass in the case where the specimen is heated under a condition providing a temperature raise rate of the temperature of the specimen of 10° C./min by using a thermogravimetric differential thermal analysis (TG-DTA) measurement device. In heating the Fe—Co alloy powder as the test specimen from room temperature with a TG-DTA measurement device, mass decrease occurs due to evaporation of attached water at the time when the temperature of the specimen exceeds 100° C., and therefore the minimum value of the mass of the specimen within a range of the temperature of the specimen of 100° C. or more and 150° C. or less is designated as the standard of the increase of the mass.

### [High Frequency Characteristics]

In the present invention, it is preferred that a molded body obtained by mixing the Fe—Co alloy powder and a bisphenol F type epoxy resin in a mass ratio of 9/1 and pressure-molding the mixture has a real part μ′ of a complex relative permeability of 6.2 or more, and more preferably 7.5 or more, and a loss coefficient tan δ of a complex relative permeability of 0.1 or less, and more preferably 0.07 or less, measured at 100 MHz. A value of μ′ that is less than 6.2 is not preferred since the effect of decreasing the size of an electronic component represented by an inductor may be decreased.

### [Fe—Co Alloy Powder Producing Step]

The Fe—Co alloy particles of the present invention can be produced by a production method according to the production method described in Japanese Patent Application No. 2017-134617 described above. The production method described in the application has the feature that the wet method is performed in the presence of the phosphorus-containing ion, and is roughly classified into three embodiments, and the Fe—Co alloy powder constituted by Fe—Co alloy particles having an average particle diameter of 0.25 μm or more and 0.80 μm or less and an average axial ratio of 1.5 or less can be obtained by any of the embodiments.

### [Starting Substance]

In the Fe—Co alloy powder producing step of the present invention, an acidic aqueous solution containing a trivalent Fe ion and a small amount of a Co ion (which may be hereinafter referred to as a raw material solution) is used as a starting substance of a Fe oxide containing a small amount of Co oxide, which is the precursor of the Fe—Co alloy powder. In the case where a divalent Fe ion is used as the starting substance instead of a trivalent Fe ion, a mixture containing a hydrated oxide of the divalent iron, magnetite, and the like, in addition to the hydrated oxide of the trivalent iron, is formed as a precipitate, which may cause variation in shape of the Fe—Co alloy particles finally obtained, failing to provide the Fe—Co alloy powder as in the present invention. The term acidic herein means pH of the solution of less than 7. The supply sources of the Fe ion and the Co ion each are preferably a water soluble inorganic acid salt, such as a nitrate, a sulfate, and a chloride, from the standpoint of the availability and the cost.

By dissolving the Fe salt and the Co salt in water, the aqueous solution exhibits acidity through hydrolysis of the Fe ion and the Co ion. By neutralizing the acidic aqueous solution containing the Fe ion and a small amount of the Co ion by adding an alkali thereto, a precipitate of Fe hydrated oxide containing a small amount of Co hydroxide or an oxyhydroxide of Co is obtained. The hydrated oxide of iron herein is a substance represented by the general formula Fe₂O₃.nH₂O, and is FeOOH (iron oxyhydroxide) when n=1, or Fe(OH)₃ (iron hydroxide) when n=3.

The Fe ion concentration in the raw material solution is not particularly determined in the present invention, and is preferably 0.01 mol/L or more and 1 mol/L or less. The concentration of less than 0.01 mol/L is not economically preferred since the amount of the precipitate obtained through single reaction is small. The Fe ion concentration that exceeds 1 mol/L is not preferred since the reaction solution tends to gel through the rapid formation of a precipitate of the hydrated oxide.

The Co ion concentration in the raw material solution is preferably such a concentration that is obtained by multiplying the Fe ion concentration by the Co ratio in consideration of the composition of the target Fe—Co alloy powder.

### [Phosphorus-Containing Ion]

In the Fe—Co alloy powder producing step in the present invention, a phosphorus-containing ion is made to co-exist at the time of the formation of the precipitate of the hydrated oxide of Fe containing a small amount of Co, or a phosphorus-containing ion is added during the addition of a silane compound for coating the hydrolyzate. In both cases, the phosphorus-containing ion co-exists in the system in coating the silane compound. The supply source of the phosphorus-containing ion may be phosphoric acid or a soluble phosphate salt (PO₄³⁻), such as ammonium phosphate, Na phosphate, monohydrogen salts thereof, and dihydrogen salts thereof. Phosphoric acid is a tribasic acid dissociating in three stages in an aqueous solution, and may be in the existing forms of a phosphate ion, a phosphate dihydrogen ion, and a phosphate monohydrogen ion in an aqueous solution. The existing form thereof is determined by the pH of the aqueous solution, but not by the kind of the reagent used as the supply source of the phosphate ion, and therefore the aforementioned ions containing a phosphoric acid group are generically referred to as a phosphate ion. As the supply source of the phosphate ion in the present invention, diphosphoric acid (pyrophosphoric acid), which is a condensed phosphoric acid, may also be used. In the present invention, instead of the phosphate ion (PO₄³⁻), a phosphite ion (PO₃³⁻) and a hypophosphite ion (PO₂²⁻) having different oxidation numbers of P may also be used. These oxide ions containing phosphorus (P) are generically referred to as a phosphorus-containing ion.

The amount of the phosphorus-containing ion added to the raw material solution is preferably 0.003 or more and 0.1 or less in terms of the molar ratio with respect to the total moles of the Fe ion and the Co ion contained in the raw material solution (P/(Fe+Co) ratio). In the case where the P/(Fe+Co) ratio is less than 0.003, the effect of increasing the average particle diameter of the Fe—Co alloy oxide powder contained in the silicon oxide-coated Fe—Co alloy oxide powder may be insufficient, and in the case where the P/(Fe+Co) ratio exceeds 0.1, the effect of increasing the particle diameter may not be obtained while the mechanism thereof is unclear. The P/(Fe+Co) ratio is more preferably 0.005 or more and 0.05 or less.

Although the mechanism that the Fe—Co alloy particles having an average particle diameter of 0.25 μm or more and 0.80 μm or less and an average axial ratio of 1.5 or less are obtained by the co-existence of the phosphorus-containing ion is unclear, the present inventors estimate that the silicon oxide coating layer described later is changed in the property thereof due to the phosphorus-containing ion contained.

The time of addition of the phosphorus-containing ion to the raw material solution may be any of before the neutralization treatment described later, after the neutralization treatment and before the coating with the silicon oxide, and during the addition of the silane compound, as described above.

### [Neutralization Treatment]

In the first embodiment of the Fe—Co alloy powder producing step of the present invention, an alkali is added to the raw material solution containing the phosphorus-containing ion under agitation with a known mechanical means, so as to neutralize the solution to make the pH thereof of 7 or more and 13 or less, thereby forming the precipitate of the hydrated oxide of iron. The examples described later will be explained based mainly on the first embodiment.

The pH after the neutralization that is less than 7 is not preferred since the Fe ion is not precipitated in the form of the hydrated oxide of Fe. The pH after the neutralization that exceeds 13 is also not preferred since the hydrolysis of the silane compound added in the silicon oxide coating step as the next step rapidly proceeds, and the coating of the hydrolyzate of the silane compound becomes non-uniform.

In the production method of the present invention, in neutralizing the raw material solution containing the phosphorus-containing ion with an alkali, a method of adding the raw material solution containing the phosphorus-containing ion to an alkali may be employed, in addition to the method of adding an alkali to the raw material solution containing the phosphorus-containing ion.

The value of pH shown in the description herein is measured according to JIS Z8802 with a glass electrode. The value is measured with a pH meter having been calibrated with a suitable buffer solution corresponding to the pH range to be measured. The pH shown in the description herein is a value that is obtained by directly reading the measured value shown by the pH meter compensated with a temperature compensated electrode, under the reaction temperature condition.

The alkali used for the neutralization may be any of a hydroxide of an alkali metal or an alkaline earth metal, aqueous ammonia, and an ammonium salt, such as ammonium hydrogen carbonate, and aqueous ammonia or ammonium hydrogen carbonate, which may leave less impurities at the time when the precipitate of the hydrated oxide of iron is finally converted to the iron oxide through the heat treatment, is preferably used. The alkali may be added in the form of solid to the aqueous solution of the starting substance, and is preferably added in the form of an aqueous solution from the standpoint of the securement of the uniformity in reaction.

After completing the neutralization reaction, the slurry containing the precipitate is retained at that pH for 5 minutes to 24 hours under stirring, so as to age the precipitate.

In the production method of the present invention, the reaction temperature in the neutralization treatment is not particularly defined, and is preferably 10° C. or more and 90° C. or less. The reaction temperature that is less than 10° C. or exceeds 90° C. is not preferred in consideration of the energy cost required for controlling the temperature.

In the second embodiment of the production method of the present invention, an alkali is added to the raw material solution under agitation with a known mechanical means to perform neutralization until the pH thereof reaches 7 or more and 13 or less, so as to form the precipitate of the hydrated oxide of iron, and then in the step of aging the precipitate, the phosphorus-containing ion is added to the slurry containing the precipitate. The time of addition of the phosphorus-containing ion may be immediately after the formation of the precipitate or during the aging. The aging time and the reaction temperature of the precipitate in the second embodiment may be the same as those in the first embodiment.

In the third embodiment of the production method of the present invention, an alkali is added to the raw material solution under agitation with a known mechanical means to perform neutralization until the pH thereof reaches 7 or more and 13 or less, so as to form the precipitate of the hydrated oxide of iron, and then the precipitate is aged. In this embodiment, the phosphorus-containing ion is added in coating the silicon oxide.

[Coating with Hydrolyzate of Silane Compound]

In the Fe—Co alloy powder producing step of the present invention, the precipitate of the hydrated oxide of Fe containing a small amount of Co formed through the preceding steps is coated with the hydrolyzate of the silane compound. The coating method of the hydrolyzate of the silane compound is preferably a so-called sol-gel method.

In the sol-gel method, a silicon compound having a hydrolyzable group, such as tetraethoxysilane (TEOS) and tetramethoxysilane (TMOS), or a silane compound, such as various silane coupling agents, is added to the slurry of the precipitate of the hydrated oxide of iron to perform hydrolysis reaction under agitation, and the surface of the precipitate of the hydrated oxide of Fe is coated with the hydrolyzate of the silane compound thus formed. At this time, an acid catalyst or an alkali catalyst may be added, and the catalyst is preferably added in consideration of the treating time. Representative examples of the acid catalyst include hydrochloric acid, and representative examples of the alkali catalyst include ammonia. In the case where an acid catalyst is used, it is necessary that the amount thereof added is limited to such an amount that the precipitate of the hydrated oxide of Fe is not dissolved.

The specific method of coating the hydrolyzate of the silane compound may be the same as the sol-gel method in the known process, and the ratio of the total molar number of the Fe ion and the Co ion charged in the raw material solution and the total molar number of Si contained in the silicon compound dripped to the slurry (Si/(Fe+Co) ratio) may be 0.05 or more and 0.5 or less. The reaction temperature in the coating with the hydrolyzate of the silane compound by the sol-gel method may be 20° C. or more and 60° C. or less, and the reaction time therefor may be approximately 1 h or more and 20 h or less.

In the third embodiment of the Fe—Co alloy powder producing step of the present invention, the phosphorus-containing ion is simultaneously added to the slurry containing the precipitate of the hydrated oxide of Fe containing a small amount of Co obtained through the aging after the neutralization, during the period of from the start of addition of the silicon compound having a hydrolyzable group to the completion of the addition thereof. The time of addition of the phosphorus-containing ion may be simultaneous with the start of addition of the silicon oxide having a hydrolyzable group, and may be simultaneous with the completion of addition thereof.

### [Recovery of Precipitate]

The precipitate of the hydrated oxide of Fe containing a small amount of Co coated with the hydrolyzate of the silane compound is isolated from the slurry obtained through the aforementioned step. The solid-liquid separation means used may be a known solid-liquid separation means, such as filtration, centrifugal separation, and decantation. In the solid-liquid separation, an aggregating agent may be added for performing the solid-liquid separation. It is preferred that subsequently the precipitate of the hydrated oxide of Fe containing a small amount of Co coated with the hydrolyzate of the silane compound obtained through the solid-liquid separation is washed, and then solid-liquid separation thereof is performed again. The washing method may be a known washing method, such as repulping washing. The precipitate of the hydrated oxide of Fe containing a small amount of Co coated with the hydrolyzate of the silane compound thus obtained finally is subjected to a drying treatment. The drying treatment is performed for removing water attached to the precipitate, and may be performed at a temperature of approximately 110° C., which is higher than the boiling point of water.

### [Heating Treatment]

In the Fe—Co alloy powder producing step of the present invention, the precipitate of the hydrated oxide of Fe containing a small amount of Co coated with the hydrolyzate of the silane compound is subjected to a heat treatment, so as to provide Fe oxide powder containing a small amount of Co oxide coated with the silicon oxide as a precursor of the silicon oxide-coated Fe—Co alloy powder. The atmosphere of the heat treatment is not particularly determined, and may be the air atmosphere. The heating may be performed in a range approximately of 500° C. or more and 1,500° C. or less. The heat treatment temperature that is less than 500° C. is not preferred since the particles may not sufficiently grow. The temperature that exceeds 1,500° C. is not preferred since unnecessary growth of the particles and sintering of the particles may occur. The heating time may be controlled to a range of from 10 minutes to 24 hours. The hydrated oxide of iron is changed to the iron oxide through the heat treatment. The heat treatment temperature is preferably 800° C. or more and 1,250° C. or less, and more preferably 900° C. or more and 1,150° C. or less. In the heat treatment, the hydrolyzate of the silane compound covering the precipitate of the hydrated oxide of Fe containing a small amount of Co is also changed to the silicon oxide. The silicon oxide coating layer also has a function preventing the sintering of the precipitate of the hydrated oxide of Fe containing a small amount of Co in the heat treatment.

### [Reducing Heat Treatment]

In the Fe—Co alloy powder producing step of the present invention, the Fe oxide powder containing a small amount of Co oxide coated with the silicon oxide as the precursor obtained in the preceding step is subjected to a heat treatment in a reducing atmosphere, so as to provide silicon oxide-coated Fe—Co alloy powder. Examples of the gas forming the reducing atmosphere include hydrogen gas and a mixed gas of hydrogen gas and an inert gas. The temperature of the reducing heat treatment may be in a range of 300° C. or more and 1,000° C. or less. The temperature of the reducing heat treatment that is less than 300° C. is not preferred since the reduction of the iron oxide may be insufficient. With the temperature that exceeds 1,000° C., the effect of reduction may be saturated. The heating time may be controlled to a range of from 10 to 120 minutes.

### [Stabilization Treatment]

The Fe—Co alloy powder obtained through the reducing heat treatment generally has a surface that is significantly chemically active, and therefore is frequently subjected to a stabilization treatment through gradual oxidation. The Fe—Co alloy powder obtained in the Fe—Co alloy powder producing step of the present invention has a surface that is coated with the silicon oxide, which is chemically inert, but there is a case where a part of the surface thereof is not coated, and therefore the stabilization treatment is preferably performed to form an oxidized protective layer on the exposed portion on the surface of the Fe—Co alloy powder. Examples of the procedure of the stabilization treatment include the following.

The atmosphere, to which the silicon oxide-coated Fe—Co alloy powder after the reducing heat treatment is exposed, is replaced from the reducing atmosphere to an inert gas atmosphere, and the oxidation reaction of the exposed portion is performed at a temperature of from 20 to 200° C., preferably from 60 to 100° C., while the oxygen concentration in the atmosphere is slowly increased. The inert gas used may be at least one gas component selected from a rare gas and nitrogen gas. The oxygen-containing gas used may be pure oxygen gas and the air. Water vapor may also be introduced along with the oxygen-containing gas. The oxygen concentration, at which the silicon oxide-coated Fe—Co alloy powder is retained at a temperature of from 20 to 200° C., preferably from 60 to 100° C., may be finally from 0.1 to 21% by volume. The introduction of the oxygen-containing gas may be performed continuously or intermittently. In the initial stage of the stabilization step, the period of time when the oxygen concentration is 1.0% by volume or less is preferably kept for 5.0 minutes or more.

### [Dissolution Treatment of Silicon Oxide Coating]

The pure Fe—Co alloy powder without coating can be obtained by completely removing the silicon oxide coating from the silicon oxide-coated Fe—Co alloy powder described above. The removal of the non-magnetic silicon oxide coating may enhance the magnetic characteristics of the Fe—Co alloy powder.

The alkali aqueous solution used for the dissolution treatment may be an ordinary alkali aqueous solution that is industrially used, such as a sodium hydroxide solution, a potassium hydroxide solution, and aqueous ammonia. The pH of the treatment liquid is preferably 10 or more, and the temperature of the treatment liquid is preferably 60° C. or more and the boiling point or less, in consideration of the treatment time and the like.

A prolonged period of time may be required for completely removing the silicon oxide coating, and therefore Si that remains in an amount of approximately 2.0% by mass based on the Fe—Co alloy powder may be allowed.

### [Solid-Liquid Separation and Drying]

The Fe—Co alloy powder is recovered from the slurry containing the Fe—Co alloy powder obtained through the aforementioned sequence of steps, by a known solid-liquid separation means. The solid-liquid separation means used may be a known solid-liquid separation means, such as filtration, centrifugal separation, and decantation. In the solid-liquid separation, an aggregating agent may be added for performing the solid-liquid separation.

### [Pulverization Treatment]

The Fe—Co alloy powder obtained through the dissolution treatment of the silicon oxide coating layer may be pulverized. The pulverization can decrease the volume based cumulative 50% particle diameter of the Fe—Co alloy powder measured by a Microtrac measurement device. The pulverizing method may be a known method, such as a method by a pulverizing device using a medium, such as a bead mill, and a medialess pulverizing device, such as a jet mill. The medialess pulverizing device is preferably used, and a jet mill pulverizing device is more preferably used since in the method by the pulverizing device using a medium, there is a possibility that the shape of the particles of the resulting Fe—Co alloy powder is changed to increase the axial ratio, resulting in the decrease of the packing density of the Fe—Co alloy powder in the formation of a molded body in the later step, the deterioration of the magnetic characteristics of the Fe—Co alloy powder, and the like. The jet mill pulverizing device herein means a pulverizing device of the system in which an object to be pulverized or a slurry obtained by mixing an object to be pulverized and a liquid is sprayed with a high pressure gas and made to collide with a collision plate or the like. A device of the type of spraying the object to be pulverized with a high pressure gas without the use of a liquid is referred to as a dry jet mill pulverizing device, and a device of the type of using a slurry obtained by mixing the object to be pulverized and a liquid is referred to as a wet jet mill pulverizing device. The target, with which the object to be pulverized or the slurry obtained by mixing the object to be pulverized and a liquid is made to collide, may not be a stationary target, such as a collision plate, but a method of making the object to be pulverized sprayed with a high pressure gas to collide with each other, or making the slurry obtained by mixing the object to be pulverized and a liquid to collide with each other may be used.

The liquid used in the case where the pulverization is performed with the wet jet mill pulverizing device may be an ordinary dispersion medium, such as pure water and ethanol, and ethanol is preferably used.

In the case where the wet jet mill pulverizing device is used for the pulverization, a slurry as a mixture of the pulverized Fe—Co alloy powder and the dispersion medium is obtained after the pulverization treatment, and the pulverized Fe—Co alloy powder can be obtained by drying the dispersion medium in the slurry. The drying method may be a known method, and the atmosphere therefor may be the air. From the standpoint of the prevention of oxidation of the Fe—Co alloy powder, however, drying in a non-oxidative atmosphere, such as nitrogen gas, argon gas, or hydrogen gas, or vacuum drying is preferably performed. The drying is preferably performed under heating, for example, to 100° C. or more for increasing the drying rate. In the case where the Fe—Co alloy powder obtained after drying is again mixed with ethanol and then subjected to the Microtrac particle size distribution measurement, D50 of the Fe—Co alloy powder in the slurry after the pulverization treatment can be substantially reproduced. In other words, D50 of the Fe—Co alloy powder is not changed before and after drying.

### [Particle Diameter]

The particle diameter of the Fe—Co alloy particles is obtained by the observation with a scanning electron microscope (SEM). The SEM observation was performed by using S-4700, produced by Hitachi High-Tech Corporation.

In the SEM observation, for one particle, the length of the long edge of the rectangle having the minimum area that was circumscribed on the particle is designated as the particle diameter of the particle. The distance between lines herein means the length of the segment of the line drawn perpendicular to the two parallel lines. Specifically, on an SEM micrograph taken at a magnification of 5,000, 300 particles each having an outer contour, the entire of which was observed within the view field, were randomly selected and measured for the particle diameter, and the average value thereof was designated as the average particle diameter of the Fe—Co alloy powder.

### [Axial Ratio]

For one particle on an SEM micrograph, the length of the short edge of the rectangle having the minimum area that is circumscribed on the particle is referred to as the “minor diameter”, and the ratio of (particle diameter)/(minor diameter) is referred to as the “axial ratio” of the particle. The “average axial ratio”, which is the average of the axial ratios of the powder, can be determined as follows. 300 particles randomly selected are measured for the “particle diameter” and the “minor diameter” by the SEM observation, the average value of the particle diameters and the average value of the minor diameters of all the particles measured are designated as the “average particle diameter” and the “average minor diameter” respectively, and the ratio (average particle diameter)/(average minor diameter) is designated as the “average axial ratio”. In the case where the number of particles each having an outer contour, the entire of which was observed within one view field, is less than 300, the measurement may be performed until the number of the particles reaches 300 in total by taking plural SEM micrographs for other view fields.

### [Compositional Analysis]

In the compositional analysis of the Fe—Co alloy powder, the contents of Fe, Co, and P (% by mass) are obtained, after dissolving the Fe—Co alloy powder, by the high frequency inductively coupled plasma atomic emission spectrometry (ICP-AES) with ICP-720ES emission spectrometer, produced by Agilent Technologies, Inc. The Si content (% by mass) of the Fe—Co alloy powder is obtained by the method for determination of silicon content described in JIS M8214-1995.

### [Magnetic Characteristics]

The B-H curve is measured with VSM (VSM-P7, produced by Toei Industry Co., Ltd.) under an applied magnetic field of 795.8 kA/m (10 kOe), and the coercive force Hc and the saturation magnetization as are evaluated.

### [Complex Permeability]

The Fe—Co alloy powder and a bisphenol F type epoxy resin (one-component epoxy resin B-1106, produced by Tesk Co., Ltd.) are weighed at a mass ratio of 90/10, and kneaded with a vacuum agitation deaeration mixer (V-mini 300, produced by EME Corporation), so as to provide a paste having the test powder dispersed in the epoxy resin. The paste is dried on a hot plate at 60° C. for 2 hours to provide a composite of the metal powder and the resin, which is then pulverized into particles, which are designated as composite powder. 0.2 g of the composite powder is placed in a toroidal vessel and applied with a load of 9,800 N (1 ton) with a hand press to provide a molded body having a toroidal shape having an outer diameter of 7 mm and an inner diameter of 3 mm. The molded body is measured for the real part μ′ and the imaginary part μ″ of the complex relative permeability at 100 MHz with an RF impedance/material analyzer (E4991A, produced by Agilent Technologies, Inc.) and a test fixture (16454A, produced by Agilent Technologies, Inc.), and the loss factor of the complex relative permeability tan δ=μ″/μ′ is obtained. In the description herein, the real part μ′ of the complex relative permeability may be referred to as the “permeability” or “μ′”.

The molded body produced by using the Fe—Co alloy powder of the present invention exhibits excellent complex permeability characteristics, and can be favorably used as a magnetic core of an inductor.

### [BET Specific Surface Area]

The BET specific surface area is obtained by the BET one-point method with Macsorb model 1210, produced by Mountech Co., Ltd.

### [Heat Resisting Temperature]

The heat resisting temperature is measured in such a manner that the temperature at which the mass of the specimen increases by 1.0% by mass under conditions of a mass of the specimen of approximately 20 mg, an air flow rate of 0.2 L/min, and a temperature raise rate of the temperature of the specimen of 10° C./min by using a TG-DTA measurement device, produced by Hitachi High-Tech Science Corporation, is measured and designated as the heat resisting temperature. The mass of the specimen used as the standard of the increase of the mass is the minimum value of the mass of the specimen within a range of the temperature of the specimen of 100° C. or more and 150° C. or less.

The heat resistance of the Fe-Co binary system can be enhanced in the present invention, and the heat resistance can be enhanced also in a ternary or higher system having another element added thereto. Specifically, assuming (Co+M)/(Fe+Co+M) molar ratio, wherein M represents another element (including one or more of Ni, Mn, Cr, Mo, Cu, and Ti), the (Co+M)/(Fe+Co+M) molar ratio is set within a range of from 0.0001 to 5.0.

### EXAMPLES

### Example 1

In a 5 L reaction tank, 563.78 g of iron(III) nitrate nonahydrate having a purity of 99.7% by mass, 1.97 g of cobalt(II) nitrate hexahydrate having a purity of 98.0% by mass, and 2.78 g of a 85% by mass H₃PO₄ aqueous solution were dissolved in 4,089.92 g of pure water in the air atmosphere under mechanical agitation with agitation blades (procedure 1). The solution had pH of approximately 1. Under the condition, the Co/(Fe+Co) molar ratio in the preparation was 0.005, and the P/(Fe+Co) molar ratio of the P element contained in phosphoric acid with respect to the total amount of the trivalent Fe ion and the Co ion contained in the solution was 0.017.

In the air atmosphere, 430.65 g of a 22.30% by mass ammonia solution was added to the solution under mechanical agitation with agitation blades under a condition of 30° C. over 10 minutes, and after completing the dripping, the precipitate of the Fe hydroxide containing a small amount of Co thus formed was aged by continuing the agitation for 30 minutes. At this time, the slurry containing the precipitate had pH of approximately 9 (procedure 2).

110.36 g of tetraethoxysilane (TEOS) having a purity of 95.0% by mass was dripped to the slurry obtained in the procedure 2 under agitation in the air at 30° C. over 10 minutes. Thereafter, the agitation was continued for 20 hours, and thereby the precipitate was coated with the hydrolyzate of the silane compound formed through hydrolysis (procedure 3). The Si/(Fe+Co) molar ratio of the amount of the Si element contained in the tetraethoxysilane dripped to the slurry and the total amount of the tetravalent Fe ion and the Co ion contained in the solution was 0.36.

The slurry obtained in the procedure 3 was filtered, and after draining off water contained in the resulting precipitate of the Fe hydroxide containing a small amount of Co coated with the hydrolyzate of the silane compound as much as possible, the precipitate was again dispersed in pure water for repulping washing. The slurry after washing was again filtered, and the resulting cake was dried in the air at 110° C. (procedure 4).

The dried product obtained in the procedure 4 was subjected to a heat treatment in the air at 1,048° C. for 4 hours with a box type baking furnace, so as to provide the Fe oxide containing a small amount of Co coated with the silicon oxide (procedure 5). The production conditions including the preparation condition of the raw material solution are shown in Table 1.

19 g of the Fe oxide containing a small amount of Co coated with the silicon oxide obtained in the procedure 5 was placed in an aerated bucket, and a reducing heat treatment was performed by charging the bucket in a through type reducing furnace and retaining at 630° C. for 40 minutes while flowing hydrogen gas in the furnace at a flow rate of 20 NL/min, so as to provide the silicon oxide-coated Fe—Co alloy powder (procedure 6).

Subsequently, the atmospheric gas in the furnace was changed from hydrogen to nitrogen, and the temperature in the furnace was decreased to 80° C. at a temperature fall rate of 20° C./min under flowing nitrogen gas. Thereafter, a mixed gas of nitrogen gas and the air at a volume ratio of nitrogen gas/air of 125/1 (oxygen concentration: approximately 0.17% by volume) as the initial gas for performing a stabilization treatment was introduced to the furnace for 10 minutes to initiate the oxidation reaction of the surface layer portion of the metal powder particles, thereafter a mixed gas of nitrogen gas and the air at a volume ratio of nitrogen gas/air of 80/1 (oxygen concentration: approximately 0.26% by volume) was introduced to the furnace for 10 minutes, further a mixed gas of nitrogen gas and the air at a volume ratio of nitrogen gas/air of 50/1 (oxygen concentration: approximately 0.41% by volume) was introduced to the furnace for 10 minutes, and finally a mixed gas of nitrogen gas and the air at a volume ratio of nitrogen gas/air of 25/1 (oxygen concentration: approximately 0.80% by volume) was introduced to the furnace for 10 minutes continuously, so as to form an oxidized protective layer on the surface layer portion of the Fe—Co alloy particles. In the stabilization treatment, the temperature was retained to 80° C., and the flow rate of the gas introduced was retained to the substantially constant value (procedure 7).

The silicon oxide-coated Fe—Co alloy powder obtained in the procedure 7 was immersed in a 10% by mass sodium hydroxide aqueous solution at 60° C. for 24 hours to dissolve the silicon oxide coating, so as to provide Fe—Co alloy powder of Example 1.

The Fe—Co alloy powder obtained through the sequence of steps was subjected to the measurement of the magnetic characteristics, the BET specific surface area, the thermogravimetry, the particle diameter of the iron-cobalt particles, and the complex permeability, and the compositional analysis. The measurement results are shown in Table 2.

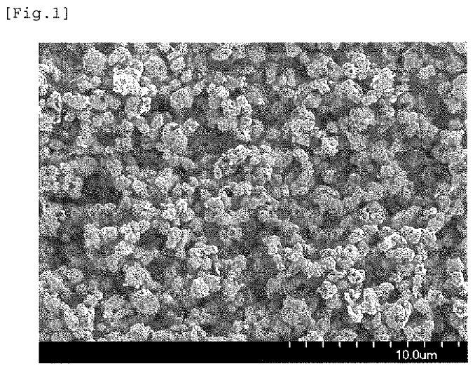

FIG. 1 shows the SEM observation result of the Fe—Co alloy powder obtained in Example 1. In FIG. 1, the length shown by the 11 white vertical lines shown in the right lower part of the SEM micrograph is 10.0 μm. The Fe—Co alloy powder had a Co ratio of 0.0048, which was substantially equal to 0.005 as the Co/(Fe+Co) molar ratio in the preparation. The average particle diameter was 0.71 μm, μ′ was 9.52, and the heat resisting temperature at the 1.0% mass increase was 255° C.

As the iron powder of the comparative example described later has a heat resisting temperature of 217° C., it is found that the Fe—Co alloy powder of the present invention has a higher heat resisting temperature than the iron powder while satisfying the small particle diameter and the high μ′. It is also found that a molded body produced with the Fe—Co alloy powder of the present invention is favorable as a magnetic core of an inductor due to the excellent complex permeability exhibited thereby.

### Examples 2 to 4

Fe—Co alloy powder was obtained under the same condition as in Example 1 except that the baking temperature in the procedure 5 was changed. The production conditions of the Fe—Co alloy powder are shown in Table 1, and the characteristics of the resulting Fe—Co alloy powder are shown in Table 2.

### Example 5

Fe—Co alloy powder was obtained under the same condition as in Example 1 except that in the procedure 1, the mass of the iron(III) nitrate nonahydrate was changed to 561.09 g, and the mass of the cobalt(II) nitrate hexahydrate was changed to 3.94 g. In this case, the Co/(Fe+Co) molar ratio in the preparation was 0.009. The production conditions of the Fe—Co alloy powder are shown in Table 1, and the characteristics of the resulting Fe—Co alloy powder are shown in Table 2.

### Example 6

Fe—Co alloy powder was obtained under the same condition as in Example 1 except that in the procedure 1, the mass of the iron(III) nitrate nonahydrate was changed to 539.55 g, and the mass of the cobalt(II) nitrate hexahydrate was changed to 19.72 g. In this case, the Co/(Fe+Co) molar ratio in the preparation was 0.048. The production conditions of the Fe—Co alloy powder are shown in Table 1, and the characteristics of the resulting Fe—Co alloy powder are shown in Table 2.

### Example 7

Fe—Co alloy powder was obtained under the same condition as in Example 1 except that in the procedure 1, the mass of the iron(III) nitrate nonahydrate was changed to 565.93 g, and the mass of the cobalt(II) nitrate hexahydrate was changed to 0.39 g. In this case, the Co/(Fe+Co) molar ratio in the preparation was 0.001. The production conditions of the Fe—Co alloy powder are shown in Table 1, and the characteristics of the resulting Fe—Co alloy powder are shown in Table 2.

In all Examples, the resulting Fe—Co alloy powder had a better heat resisting temperature than the pure iron powder of the comparative example.

### Comparative Example 1

Iron powder was obtained under the same condition as in Example 1 except that cobalt(II) nitrate hexahydrate was not added to the raw material solution, and the baking temperature was changed to 1,050° C. The production conditions are shown in Table 1, and the magnetic characteristics, the BET specific surface area, the thermogravimetry, and the complex permeability, and the results of the compositional analysis of the resulting iron powder are shown in Table 2. The iron powder obtained in the comparative example had a heat resisting temperature that was inferior to those of the Fe—Co alloy powder obtained in Examples.

TABLE 1

| | Precursor production condition | | | Baking |
|---|---|---|---|---|
| | (molar ratios in preparation) | | | temperature |
| | Co/(Fe + Co) | Si/(Fe + Co) | P/(Fe + Co) | (° C.) |
| Example 1 | 0.005 | 0.36 | 0.017 | 1048 |
| Example 2 | 0.005 | 0.36 | 0.017 | 1018 |
| Example 3 | 0.005 | 0.36 | 0.017 | 1038 |
| Example 4 | 0.005 | 0.36 | 0.017 | 1078 |
| Example 5 | 0.009 | 0.36 | 0.017 | 1048 |
| Example 6 | 0.048 | 0.36 | 0.017 | 1048 |
| Example 7 | 0.001 | 0.36 | 0.017 | 1048 |
| Comparative | 0 | 0.36 | 0.017 | 1050 |
| Example 1 | | | | |

TABLE 2

| | Fe—Co alloy powder | | | | | | | | | | | | Compound | |
|---|---|---|---|---|---|---|---|---|---|---|---|---|---|---|
| | BET | Magnetic characteristics | | SEM observation result | | | | | | | | Heat | high | |
| | specific | Coercive | Saturation | Average | Average | Aver- | Composition | | | | | resisting | frequency | |
| | surface | force | magneti- | particle | minor | age | Fe | Co | P | Si | Co/ | temp- | characteristics | |
| | area | Hc | zation σs | diameter | diameter | axial | (% by | (% by | (% by | (% by | (Fe + Co) | erature | (100 MHz) | |
| | (m²/g) | (kA/m) | (Am²/kg) | (μm) | (μm) | ratio | mass) | mass) | mass) | mass) | molar ratio | (° C.) | μ′ | tanδ |
| Example 1 | 8.3 | 4.1 | 186.1 | 0.71 | 0.61 | 1.17 | 93.3 | 0.45 | 0.31 | 0.13 | 0.0048 | 255 | 9.52 | 0.026 |
| Example 2 | 12.0 | 5.3 | 182.2 | 0.41 | 0.36 | 1.15 | 93.2 | 0.43 | 0.17 | 0.41 | 0.0046 | 228 | 7.85 | 0.026 |
| Example 3 | 9.4 | 4.9 | 185.1 | 0.51 | 0.45 | 1.14 | 93.6 | 0.40 | 0.12 | 0.28 | 0.0043 | 241 | 10.29 | 0.055 |
| Example 4 | 7.5 | 4.8 | 192.8 | 0.71 | 0.65 | 1.11 | 93.5 | 0.45 | 0.41 | 0.17 | 0.0048 | 251 | 9.86 | 0.067 |
| Example 5 | 11.0 | 5.3 | 179.7 | 0.45 | 0.39 | 1.16 | 93.1 | 0.90 | 0.20 | 0.19 | 0.0096 | 245 | 6.81 | 0.018 |
| Example 6 | 17.1 | 8.8 | 178.7 | 0.32 | 0.28 | 1.15 | 87.4 | 4.53 | 0.18 | 0.55 | 0.0493 | 225 | 6.26 | 0.016 |
| Example 7 | 11.8 | 4.8 | 182.8 | 0.48 | 0.42 | 1.14 | 93.2 | 0.03 | 0.24 | 0.30 | 0.0003 | 238 | 7.90 | 0.016 |
| Compara- | 11.7 | 5.5 | 182.7 | 0.45 | 0.33 | 1.37 | 94.7 | — | 0.25 | <0.1 | — | 217 | 6.55 | 0.015 |
| tive | | | | | | | | | | | | | | |
| Example 1 | | | | | | | | | | | | | | |

1. Fe—Co alloy powder comprising Fe—Co alloy particles containing Co in a Co/(Fe+Co) molar ratio of 0.0001 or more and 0.05 or less, having an average particle diameter of 0.25 μm or more and 0.80 μm or less, and an average axial ratio of 1.5 or less.

2. The Fe—Co alloy powder according to claim 1, wherein the Fe—Co alloy powder has a P content of 0.05% by mass or more and 1.0% by mass or less based on the mass of the Fe—Co alloy powder.

3. The Fe—Co alloy powder according to claim 1, wherein the Fe—Co alloy powder has a heat resisting temperature of 225° C. or more, which is defined by a temperature at which the mass of the Fe—Co alloy powder increases by 1.0% by mass under heating in the air under a condition providing a temperature raise rate of a temperature of a specimen of 10° C./min.

4. The Fe—Co alloy powder according to claim 1, wherein a molded body obtained by mixing the Fe—Co alloy powder and a bisphenol F type epoxy resin in a mass ratio of and pressure-molding the mixture has a real part μ′ of a complex relative permeability of 6.2 or more and a loss coefficient tan δ of a complex relative permeability of 0.1 or less, measured at 100 MHz.

5. A molded body for an inductor comprising the Fe—Co alloy powder according to claim 1.

6. An inductor comprising the Fe—Co alloy powder according to claim 1.
